(19) United States
(12) Patent Application Publication
(10) Pub. No.: US 2015/0093685 A1
(43) Pub. Date: Apr. 2, 2015

(54) Platinum Based Oxygen Reaction Reduction Catalyst

(71) Applicant: Ford Global Technologies, LLC, Dearborn, MI (US)

(72) Inventors: Jun Yang, Ann Arbor, MI (US); Patrick Pietrasz, Vancouver (CA); Chunchuan Xu, Bloomfield Hills, MI (US); Shinichi Hirano, West Bloomfield, MI (US)

(73) Assignee: Ford Global Technologies, LLC, Dearborn, MI (US)

(21) Appl. No.: 14/044,279

(22) Filed: Oct. 2, 2013

(51) Int. Cl. H01M 4/86; H01M 4/90; H01M 4/92; H01M 4/88

(52) U.S. Cl. CPC H01M 4/8657; H01M 4/8825; H01M 4/9016; H01M 4/921
USPC 429/524; 502/182; 502/185; 502/5; 429/528

(57) ABSTRACT

An oxygen reduction reaction catalyst and method for making the catalyst includes a graphitized carbon substrate with an amorphous metal oxide layer overlying the surface of the substrate. The amorphous metal oxide layer has a worm-like structure. A catalyst overlies the metal oxide layer.

### TECHNICAL FIELD

The present disclosure relates to a platinum based oxygen reduction catalyst.

### BACKGROUND

A durable, highly active oxygen reduction reaction (ORR) catalyst is an important candidate in developing proton exchange membrane fuel cell (PEMFC) vehicles. For many years, it has been known that platinum (Pt) based particles can be used as an oxygen reduction catalyst. Ways to improve the durability of the ORR and to enhance the reaction activity have been the focus of world-wide research for the past several decades.

### SUMMARY

The present invention solves one or more problems of the prior art by providing in at least one embodiment an oxygen reduction reaction catalyst and method for making the catalyst. The catalyst comprises a graphitized carbon substrate with an amorphous metal oxide layer overlying the surface of the substrate. The amorphous metal oxide layer has a worm-like structure. A catalyst overlies the metal oxide layer.

In another embodiment, oxygen reduction reaction catalyst comprising platinum is provided. The catalyst comprises a substrate with an amorphous metal oxide layer overlying a surface of the substrate. The amorphous metal oxide layer has a worm-like structure. A platinum catalyst layer having a crystalline, 2-D connected film structure overlies the metal oxide layer.

In another embodiment, a method of forming an oxygen reduction reaction catalyst is provided. The method comprises depositing a metal oxide onto a substrate to form a metal oxide layer having a conductive, amorphous worm-like structure; and depositing a crystalline platinum film having a 2-D connected structure onto the metal oxide layer to form an oxygen reduction reaction catalyst.

### BRIEF DESCRIPTION OF THE DRAWINGS

FIG. 1 is a fragmented schematic cross-sectional view of a thin film platinum based oxygen reduction catalyst incorporating an amorphous metal oxide layer according to one embodiment;

FIG. 2a is a scanning electron microscope image showing the worm-like structure of the metal oxide layer with a graphitic substrate;

FIG. 2b is a scanning electron microscope image showing the structure of the Pt on the worm-like metal oxide layer with a graphitic carbon substrate;

FIG. 3a is an x-ray diffraction pattern of the metal oxide layer in accordance with one embodiment;

FIG. 3b is an x-ray diffraction pattern of an ORR catalyst in accordance with one embodiment;

FIG. 4a is a schematic top view of a catalyst overlaying the metal oxide layer on the substrate in accordance with one embodiment;

FIG. 4b is a schematic side view of a catalyst overlaying the metal oxide layer on the substrate in accordance with one embodiment;

FIG. 4c is an expanded top view of a catalyst overlaying the metal oxide layer on the substrate in accordance with one embodiment;

FIG. 5 is a plot of ECSA performance as a function of number of cycles in accordance with one embodiment;

FIG. 6 is a plot of oxygen reduction reaction activity loss as a function of number of cycles in accordance with one embodiment;

FIG. 7 is a schematic of the steps in the method of making a Pt based oxygen reduction reaction catalyst according to one embodiment.

### DETAILED DESCRIPTION

Reference will now be made in detail to the embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

There is still a need for improved platinum based ORR catalyst designs, and methods of making such catalysts. As a substrate for oxygen reduction reaction catalysts, graphene is the most stable carbon, but it is hard to obtain in spherical shape as nano-particles. Its application as the ORR catalyst primary support is impractical at present. Nano-particles are desired since they have a high surface area which results in an increase in reaction activity. Since the surface atoms of graphitized carbon are close to those of graphene in terms of surface carbon atomic arrangement and bonding, it can be used as a substitute for graphene. Platinum (Pt) based particles that are wet-chemically coated onto amorphous or graphitized carbon have been used as ORR catalysts. Graphitized carbon is a relatively stable support that imparts improvement of catalyst durability compared to Pt on Vulcan XC-72R, a carbon black manufactured by Cabot Corporation. A platinum based oxygen reduction catalyst on graphitized carbon, such as TKK EA carbon from Tanaka Kikinzoku Kogyo K.K. has improved durability however its ORR activity does not exhibit long term stability. The electrochemical surface area measured by hydrogen desorption (ECSA) and ORR activity at 0.9V decreases with increased potential cycling, indicating that the Pt is not interconnected and that agglomeration and dissolution still occur when graphitized carbon is used.

Fuel cell and energy storage devices lack efficient and stable catalysts. Embodiments of the present invention provide a platinum based oxygen reduction reaction catalyst that offers proven activity while maintaining exceptional durability. The use of different preparation methods is critical to achieve these attributes.

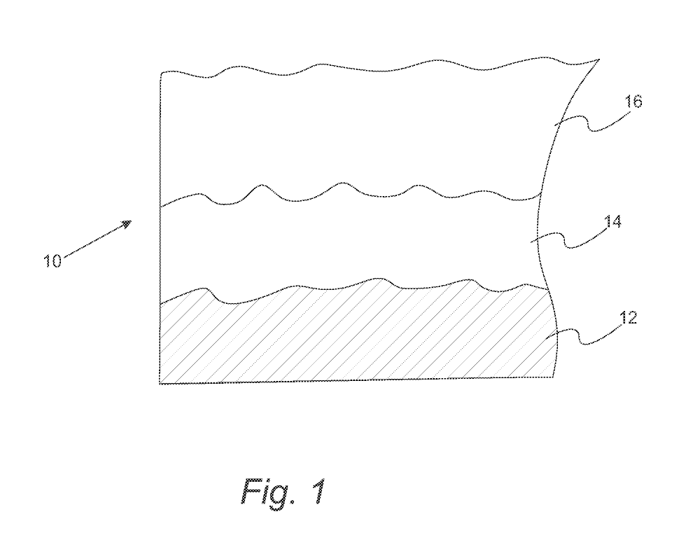

Referring now to FIG. 1, a schematic cross section of a platinum based oxygen reduction catalyst incorporating an amorphous metal oxide layer is provided. The catalyst can optionally be a component of a variety of electrochemical cells. Examples of anticipated applications include embodiments wherein the catalyst is incorporated into thin film batteries, supercapacitors, fuel cells and the like. Oxygen reduction catalyst 10 includes a substrate 12, and a metal oxide layer 14. Disposed over metal oxide layer 14 is a platinum catalyst 16. The metal oxide layer 14 inhibits a reaction between the Pt catalyst 16 and the graphitized carbon substrate 12 that results in Pt agglomeration under repeated end use cycling. Further, the metal oxide layer 14 provides an open matrix or amorphous worm-like structure so that the overlying Pt catalyst has a large surface area for promoting the electrochemical reaction.

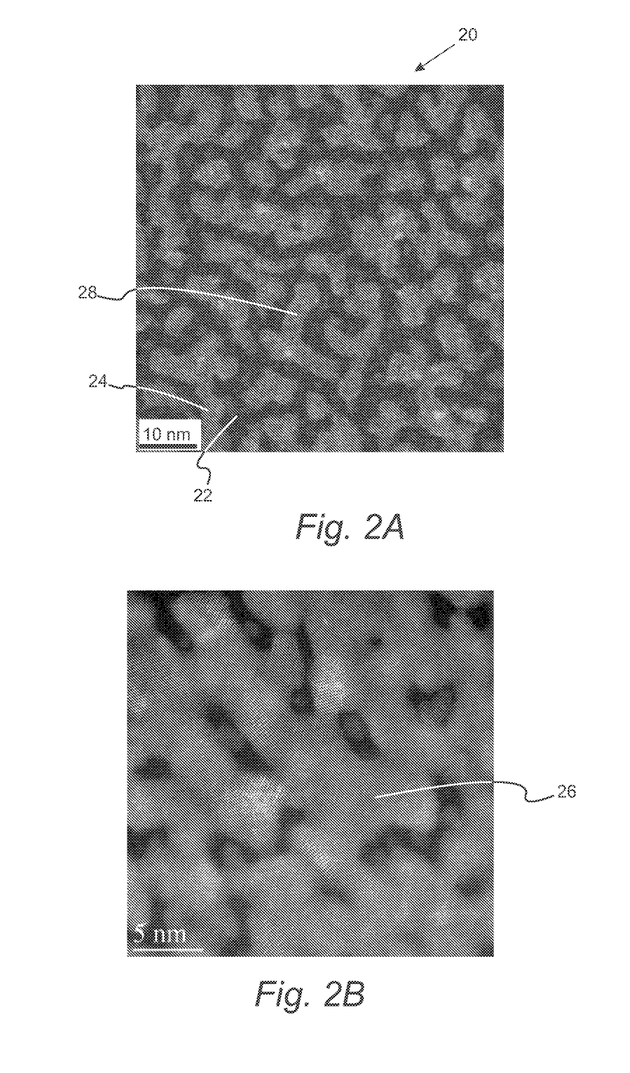

With reference to FIG. 2A, a scanning electron microscope 20 of the metal oxide layer on a substrate is provided. The substrate 22 is shown of graphitized carbon with an overlying metal oxide layer 24 having worm-like morphology 28. FIG. 2B shows a scanning electron microscope image of a 2-D connected platinum catalyst 26 overlying the metal oxide layer on the graphitized carbon substrate 22. It can be seen that the Pt catalyst 26 is crystalline, and mainly forms around the junction between NbOx and graphitic carbon, and some has formed 2-D connected clusters, similar to the targeted 2-D connected Pt network morphology.

Many embodiments of the invention involve the substrate 22 comprising nanoparticles of graphitized carbon. The substrate 22 in this embodiment can promote the growth of the a worm-like structure in the overlying metal oxide layer 24 due to the nanoparticle arrangements to be coated.

The metal oxide layer 24 may be amorphous, worm-like or discontinuous, and may be referred to as a thin film layer. A thin film layer may be a continuous or discontinuous layer having a thickness from about 5 angstroms to about 1 um. The metal oxide layer 24 is of sufficient thickness to form a worm-like structure and is limited in thickness so as to not result in a continuous coverage of the substrate. Thicker metal oxide layers tend to form continuous coverage and can grow without the worm-like structure. The metal oxide layer 24 may have (e.g., is deposited at) a physical thickness of less than 1000 angstroms. In other embodiments, the layer 24 has a thickness of less than 500 angstroms, preferably less than 300 angstroms, and more preferably less than 100 Å.

Film 24 may consist essentially of, or consist of, a metal oxide. In other embodiments, film 24 may consist essentially of, or consist of, sub-stoichiometric metal oxide (MOx where x is less than 2). In a variation of the present embodiment, the metal oxide layer can comprise one or more materials, such as oxides of niobium, molybdenum, tungsten, tantalum, titanium, indium, zinc and tin or combinations thereof. Preferably a major percentage (e.g. by weight) of the film 24 is niobium. In a refinement, the metal oxide layer may contain a mixture of two or more oxides. In one embodiment, the metal oxide layer may be 100% niobium oxide. In another embodiment, the metal oxide layer is partially niobium oxide and the remaining composition is other oxides and dopants. The percent niobium oxide in the metal oxide layer can range from 0 to 100%, and in certain embodiments from 50% to 80% and in other embodiments more than 80%

In one embodiment, the metal oxide layer may be conductive. Conductivity can range from 10² to 10⁴ /ohm centimeter. In a further refinement, the metal oxide layer may be doped to increase electrical conductivity. In yet another refinement, the metal oxide layer may be a cermet, containing both oxides and a metal for doping.

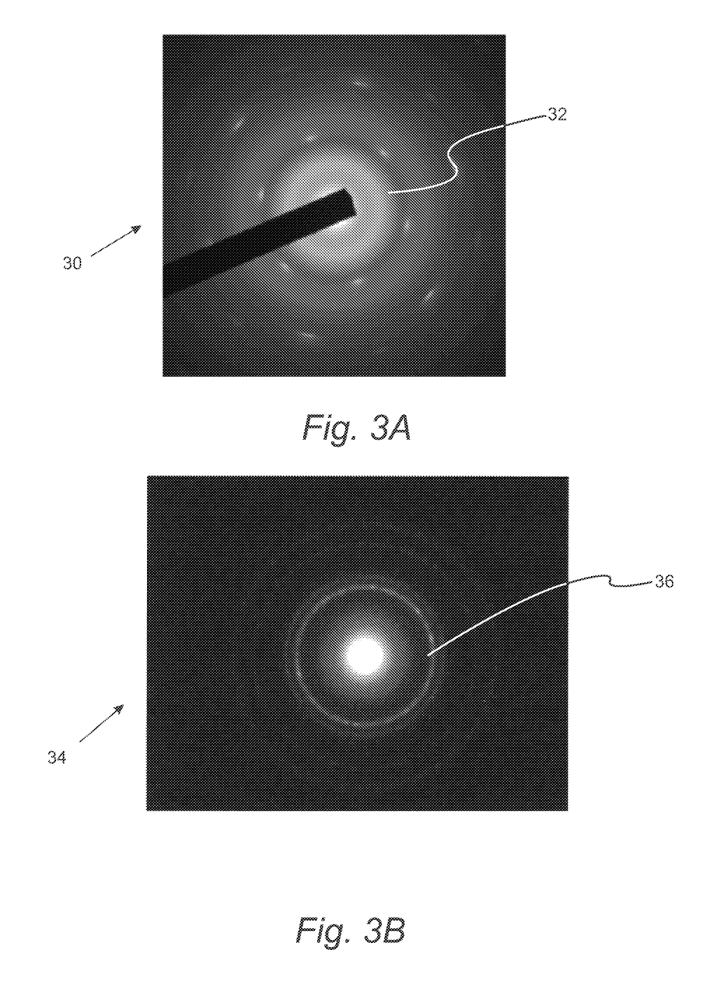

Solid materials and thin film layers may be characterized by their crystallographic atomic arrangement. Amorphous thin film layers lack long range order in contrast with the ordered atomic arrangement of crystalline materials. Selected Area X-ray Diffraction (SAED) is used to determine crystalline properties or the percent crystallinity of a material. Grazing angle X-ray diffraction is often used for thin films to increase the x-ray path length and accumulate enough signal to determine the presence or absence of a crystal structure. FIG. 3A shows SAED results 30 for a niobium oxide layer on a graphene substrate. The diffraction pattern 32 is diffuse and does not show diffraction from ordered atomic arrangements indicative of crystallinity. The niobium oxide layer is therefore of amorphous structure. FIG. 3B shows the SAED results 34 for the ORR Pt catalyst, here showing repeated diffractions 36 from atoms aligned as in the crystalline structure. The amorphous or crystalline growth of films is affected by the deposition temperature as described below and SAED serves as an important tool in determining device crystallinity and the resulting device function.

Structure zone models may be used to predict micro structure of thin films. Generally, the zone model predicts that thin films deposited at less than 30% of their melting temperature are an amorphous structure, and those deposited at temperatures greater than 30% of their melting temperature are crystalline. Deposition temperature plays a role in the resulting structure and in one embodiment, the metal oxide layer is niobium oxide because it is amorphous structurally and grows in a worm-like structure.

Referring again to FIG. 2B, the oxygen reduction reaction catalyst layer 26 can be Pt or can comprise Pt such as a Pt-based alloy. This Pt layer is deposited overlying the amorphous metal oxide layer 24 that has a worm-like structure. Unlike the worm-like structure of the metal oxide layer 24, the Pt layer 26 has a continuous, 2D connected network structure. This is accomplished by depositing a very thin Pt layer overlying the wormlike metal oxide layer 28, with thickness ranging from 5 angstroms to 100 angstroms, in one variation, ranging from 10 angstroms to 70 angstroms, and in another variation ranging from 20 angstroms to 50 angstroms.

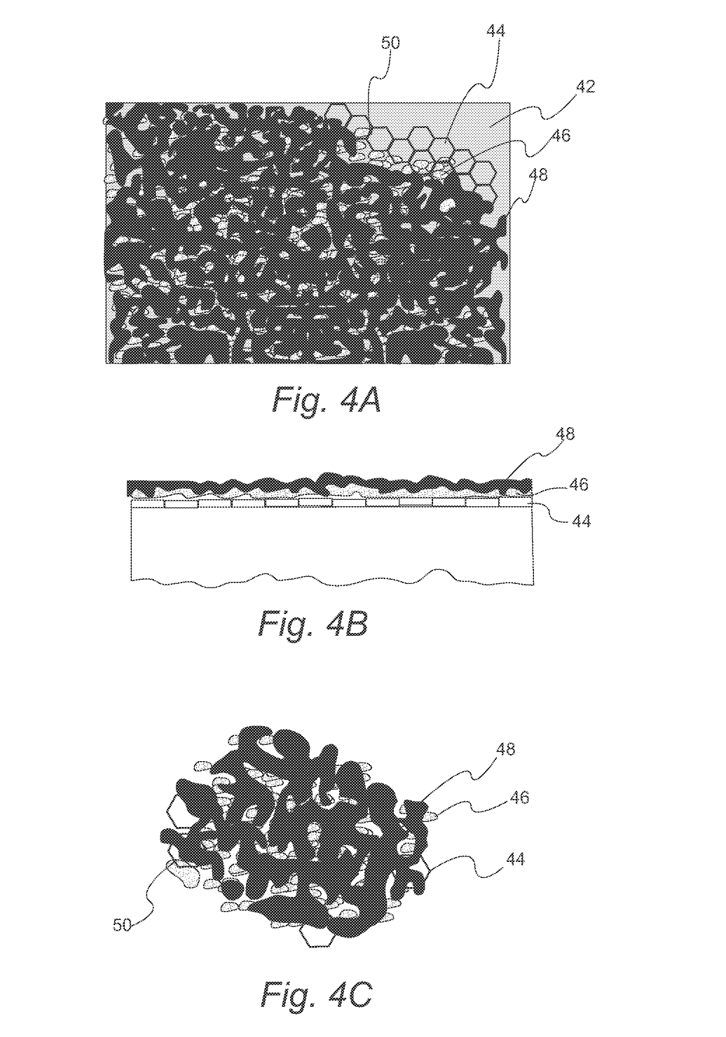

Referring now to FIG. 4A, a schematic top view of the structure of the Pt ORR catalyst is shown. The carbon substrate 42, the graphitized carbon 44, the metal oxide worm-like layer 46 and the continuous Pt catalyst 48 according to one embodiment are illustrated. During the initial stages of growth, the Pt catalyst 48 tends to form at the junction of the interface 50 of the graphitized carbon substrate 44 and the amorphous metal oxide layer 46, shown in FIG. 4C. The atomic deposition processes may occur under vacuum to enable the growing film, the Pt catalyst layer 48, to form with a desired arrangement, which can follow the underlying structure, that of metal oxide layer 46. FIG. 4B is the side view of the schematic illustrated in FIG. 4A. Referring again to FIG. 4C, it is an expanded schematic top view of FIG. 4A showing the graphitized carbon substrate 44, the metal oxide worm-like layer 46, the continuous Pt catalyst 48 and the interface 50 of the graphitized carbon substrate 44 and the amorphous metal oxide layer 46 shown.

Referring again to FIG. 1, the catalyst layer 16 is deposited onto the amorphous metal oxide layer 14 by any number of thin film vacuum deposition techniques known to those skilled in the art of thin film deposition. Examples of useful vacuum techniques include, but are not limited to, physical vapor deposition or sputtering, chemical vapor deposition, plasma assisted chemical vapor deposition, ion beam deposition and the like. In one embodiment, sputtering is found to be particularly useful because of its superior film uniformity enabling thin layers of the desired coverage. Furthermore, sputtering allows control of the process so that epitaxial growth can occur on the metal oxide layer 46 and at the interface 50 of the surface of the substrate 44 and the metal oxide layer 46, as shown in FIG. 4C. This phenomenon is well known by those skilled in the art of sputtering.

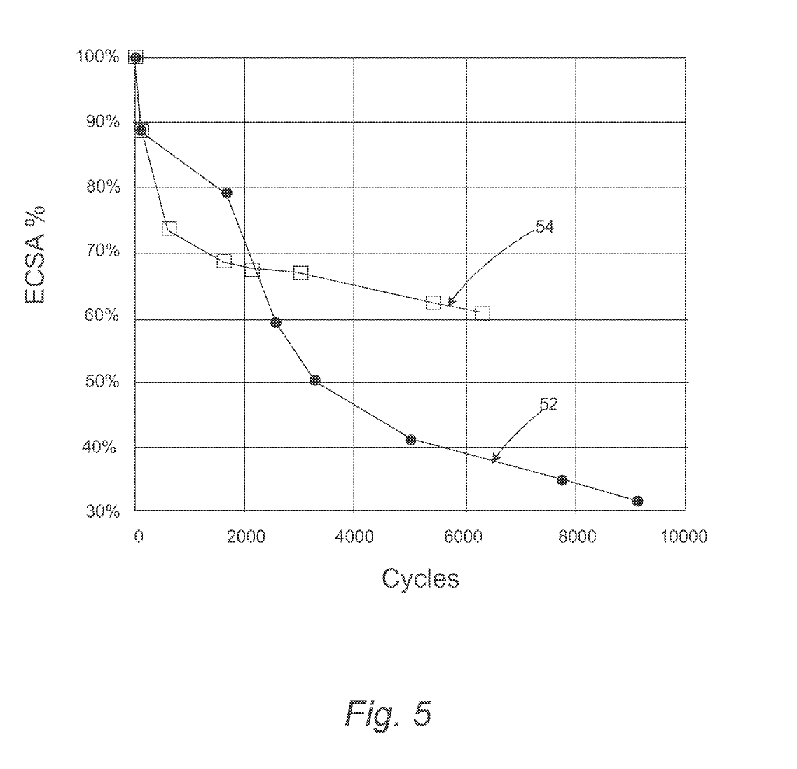

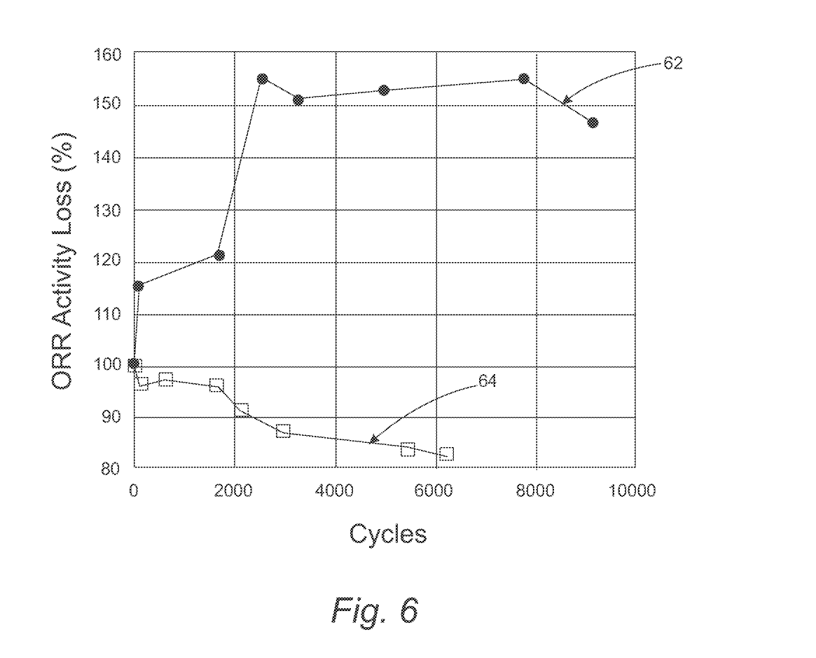

The stability of the ECSA of the ORR catalyst is shown in FIG. 5. The ORR catalyst is cycled from 0.05 volts to 1.05 volt with a scan rate of 20 mV/sec. The stability of the catalyst with the Pt overlying a niobium oxide layer 52 is comparable to that of TKK-EA50 catalyst 54 which does not contain the metal oxide layer. The ORR activity loss is depicted in the plot of FIG. 6. Again the cycling is from 0.05 volts to 1.05 volts with a scan rate of 20 mV/sec. The durability of the ORR activity of 62 is much superior to that of TKK EA50 64 in one or more embodiments.

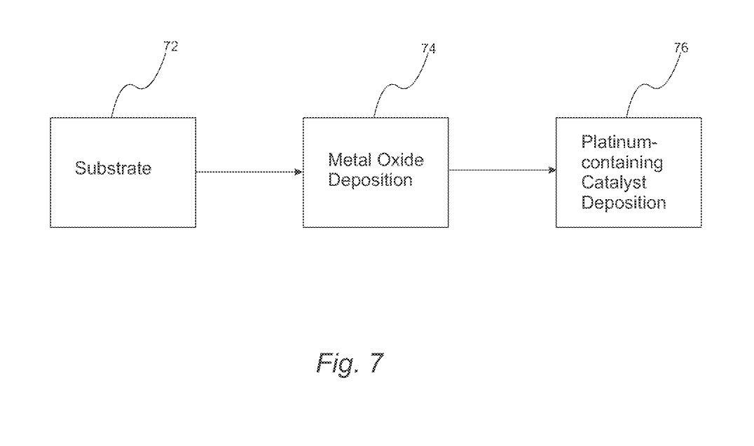

Referring now to FIG. 7 where the method of forming the platinum oxygen reduction reaction catalyst is shown schematically. The substrate 72 is coated 74 with a metal oxide layer having a conductive, amorphous worm-like structure. A platinum film having a 2-D connected structure is deposited 76 onto the metal oxide layer.

The following example illustrates the various embodiments of the present invention. Those skilled in the art will recognize many variations that are within the spirit of the present invention and scope of the claims. For example, other coating methods can include mechanical barrel-type rotation to disperse the graphitized carbon. In certain embodiments, the graphitized carbon powders can be heated to temperatures ranging from 200° C. to 700° C. In other embodiments, the PVD sputtering can be DC magnetron sputtering of metallic targets in reactive gas mixtures such as oxygen and oxygen with argon.

An ORR catalyst with niobium oxide overlaying the substrate and a catalyst overlying the niobium oxide layer is coated as follows. Highly graphitized carbon powders of 30 nm particle size are loaded into a sample dispersion system inside a vacuum sputtering chamber. The vacuum chamber is pumped to 10⁻⁶ Torr using turbo molecular pumps model Turbovac TMP 151 from Oerlikon Leybold Vacuum. Next the powders are heated to 500° C. and dispersed using ultrasonic vibration to yield a graphitized carbon substrate. The thin films are deposited onto the substrate by physical vapor deposition (PVD) using a cathode for DC magnetron sputtering. The source for the amorphous niobium oxide layer is a niobium oxide target 3 inches in diameter by 0.25 inches thick. A Pt-based target that is pure metal, and of the same dimensions, is used as the target for the platinum catalyst layer. One thousand standard cubic centimeters per minute (sccm) of argon gas is introduced into the vacuum chamber and pumped by a turbo molecular pump backed by a rotary piston mechanical pump to maintain a sputtering pressure of 5 mTorr. The sputtering is sequential, i.e., sputtering the amorphous niobium oxide first at 30 watts, followed by sputtering of the Pt catalyst at 30 watts.

The morphology of the ORR catalyst is shown in FIGS. 2A and 2B. In FIG. 2A, the NbOx 24 is amorphous, while the Pt 26 of FIG. 2B shows crystallinity and mainly forms around the junction between NbOx and graphitic carbon, while some has formed in 2-D connected clusters, similar to the targeted 2-D connected Pt network morphology.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An oxygen reduction reaction catalyst comprising:
a graphitized carbon substrate;
an amorphous metal oxide layer overlying a surface of the substrate wherein the amorphous metal oxide layer has a worm-like structure; and
a catalyst overlying the metal oxide layer.

2. The oxygen reduction reaction catalyst of claim 1, wherein the graphitized carbon substrate includes nanoparticles.

3. The oxygen reduction reaction catalyst of claim 1, wherein the amorphous metal oxide layer is discontinuous.

4. The oxygen reduction reaction catalyst of claim 1, wherein the amorphous metal oxide layer is conductive.

5. The oxygen reduction reaction catalyst of claim 1, wherein the amorphous metal oxide layer includes a niobium oxide material.

6. The oxygen reduction reaction catalyst of claim 5, wherein the niobium oxide material has a thickness ranging from 5 to 500 Angstroms.

7. The oxygen reduction reaction catalyst of claim 1, wherein the catalyst includes a platinum catalyst.

8. The oxygen reduction reaction catalyst of claim 7 wherein the platinum catalyst has a crystalline 2-D connected film structure.

9. The oxygen reduction reaction catalyst of claim 8, wherein the platinum catalyst has a thickness ranging from 10 to 50 Angstroms.

10. An oxygen reduction reaction catalyst comprising:
a substrate;
an amorphous metal oxide layer overlying a surface of a substrate wherein the amorphous metal oxide layer has a worm-like structure; and
a catalyst comprising platinum overlying the metal oxide layer having a crystalline, 2-D connected film structure.

11. The oxygen reduction reaction catalyst of claim 10, wherein the substrate includes graphitized carbon having nanoparticles.

12. The oxygen reduction reaction catalyst of claim 10, wherein the amorphous metal oxide layer includes a niobium oxide material.

13. The oxygen reduction reaction catalyst of claim 12, wherein the niobium oxide material has a thickness ranging from 5 to 500 Angstroms.

14. The oxygen reduction reaction catalyst of claim 10, wherein the catalyst includes platinum.

15. The oxygen reduction reaction catalyst of claim 14, wherein the catalyst has a thickness ranging from 10 to 50 Angstroms.

16. A method comprising:
depositing a metal oxide onto a substrate to form a metal oxide layer having a conductive, amorphous worm-like structure; and
depositing a crystalline platinum film having a 2-D connected structure onto the metal oxide layer to form an oxygen reduction reaction catalyst.

17. The method of claim 16 wherein depositing a crystalline platinum film includes depositing the crystalline platinum film by a vacuum deposition technique.

18. The method of claim 17 wherein the vacuum deposition technique is physical vapor deposition.

19. The method of claim 18 wherein depositing a crystalline platinum film includes sputtering a platinum target to form the crystalline platinum film.

20. The method of claim 16 wherein depositing a crystalline platinum film forms a platinum film at an interface of the substrate and the metal oxide layer.
